(19) United States
(12) Patent Application Publication
(10) Pub. No.: US 2021/0406964 A1
(43) Pub. Date: Dec. 30, 2021

(54) ENTERPRISE LEVEL SALES MANAGEMENT SYSTEM AND METHOD INCLUDING REAL-TIME INCENTIVE COMPENSATION

(71) Applicant: N3, LLC, Atlanta, GA (US)

(72) Inventor: Shannon COPELAND, ATLANTA, GA (US)

(73) Assignee: N3, LLC, ATLANTA, GA (US)

(21) Appl. No.: 16/916,615

(22) Filed: Jun. 30, 2020

(51) Int. Cl. G06Q 30/02; G06N 20/00; G06Q 10/06

(52) U.S. Cl. CPC G06Q 30/0281; G06Q 10/06398; G06Q 30/0201; G06N 20/00

(57) ABSTRACT

An improved enterprise level sales management system and method including a tele-agent dashboard engine that generates, as an improved user interface to automated computing machinery, a dashboard populated with customer relationship management information, dynamic scripts and industry trend information, company profile information that identifies products of interest for a particular plurality of companies and real-time tele-agent incentive compensation details. The enterprise level sales management system includes a graphical database to store semantic triples and a machine learning engine for traversing the graph and applying inference rulesets and predictive analysis algorithms, thereby improving the overall processing efficiency of the automated computing machinery.

### BACKGROUND

In the management and operation of large corporate enterprises, many critical business systems exist. These may include general ledger, accounts payable, accounts receivable, point of sales and order entry, inventory, customer relationship, payroll, manufacturing processes, job flow, shipping, and countless other business systems. For successful enterprises, it is a high priority that all systems, or as many as practicable, communicate and operate seamlessly together. That is, many corporations should ideally have a single enterprise-level business system comprising tailored subsystems all harmoniously cooperating rather than upkeeping an archipelago of independent business, financial and/or manufacturing systems with make-shift measures attempting integration. Accordingly, enterprise-level business systems may include enterprise-level databases that store all or most information describing, pertinent to, or useful in an entire corporate enterprise: Financial records, business entities and structures, employee data, incorporation data, transactions, contracts, sales history, product descriptions, and so on.

As the scope of integration, and concomitantly the size and complexity, of enterprise-level business systems increase, substantial efficiencies in business processes result. However, the functionality of the computer systems upon which the enterprise-level business systems run decreases with size, scope of integration, and complexity, thereby causing substantially increased computing requirements and mitigating gains in business efficiency. Nevertheless, large-scale integration of business systems within enterprise-level business systems facilitates enables business intelligence and collaborative enterprise planning, powered by predictive analytics and machine-learning technology.

Machine learning is closely related to (and often overlaps with) computational statistics, which also focuses on prediction-making through the use of computers. Machine learning has strong ties to mathematical optimization, which delivers methods, theory and application domains to the field. Machine learning is sometimes conflated or equated with data mining, where the latter subfield focuses more on exploratory data analysis and is sometimes known as unsupervised learning. Within the field of data analytics, machine learning is a method used to devise complex models and algorithms that lend themselves to prediction; in commercial use, this is known as predictive analytics. These analytical models allow researchers, data scientists, engineers, and analysts to produce reliable, repeatable decisions and results and uncover hidden insights through learning from historical relationships and trends in the data. Accordingly, it is desirable, and an object of the disclosure, to provide a system and method that improves the processing of computer systems running enterprise-level business systems, thereby creating increased flexibility, faster search times, smaller memory requirements, and more effective predictive analytics.

In large corporate enterprises, payroll includes data for salaried, salaried-exempt, hourly, commission plus salary, and other payroll classifications, as well as tax and insurance deductions, and the like. Modern human resource (HR) departments of large corporate enterprises typically provide employees with a computer-accessible portal whereby payroll stubs, insurance elections, deductions, and other human resource information can be viewed and managed by employees.

Within many large corporate enterprises, products and services, including cloud- or web-based products and services, computing systems and other software products, industrial goods and commodities, et cetera, are increasingly being sold over the phone by tele-agents. Such sales are often for complex systems and for very sophisticated customers.

As an aid to maximizing sales, tele-agents are often compensated in a manner that incentivizes their productivity and rewards success. Sales commissions are the most prolific example of incentive compensation. Incentive-based compensation plans other than commissions are extent, yet most plans lack the ability to directly track and reward numerous tele-agent actions, habits and factors that promote successful sale, nor is the tele-agent provided the ability to track his or her goals or earned incentive compensation in real time.

As a further aid to maximizing sales, tele-agents are often provided with a suite of tools for viewing or managing customer relationship information, order entry and status, inventory status, backlogs, historical purchase information, and the like. These may be consolidated into a single dashboard for display on a computer monitor, thereby facilitating access to the various tools and allowing for organized display and information from various sources. However, commission and incentives data remains confined to payroll and HR systems, thereby depriving tele-agents of the strong motivator of seeing their compensation as part of their tele-agent dashboard and watching it increase in real-time as they succeed in their calls. Moreover, it is difficult and cumbersome for tele-agents to track their compensation in real-time via the HR payroll portal, because it requires tele-agents to drill down though many layers, including login and security screens, to get to the desired data or functionality, and typical security protocols log users off after short periods of inactivity. As a result, such a prior art interfaces are slow, unwieldy, complex, and cumbersome to use on a regular basis. Accordingly, it is desirable, and an object of the disclosure, to provide a new and improved user interface for a tele-agent dashboard of a business system and to provide thereon various incentivization means.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram of an improved enterprise level sales management system and method including an integrated user interface enhancing incentivization and displaying in real-time compensation for tele-agents according to one or more embodiments of the present invention.

FIG. 2 is a block diagram of an improved enterprise level sales management system and method having an enterprise-level graphical database for improving overall computer performance as well as including an integrated user interface enhancing incentivization and displaying in real-time compensation for tele-agents according to one or more embodiments of the present invention.

FIG. 3 is an elevation view of an exemplary tele-agent dashboard of the improved enterprise level sales management systems and methods of FIGS. 1 and 2 according to one or more embodiments.

FIGS. 4 and 5 are flowcharts of a process for improving the efficiency of an enterprise sales management system according to one or more embodiments, which may be implemented by the systems of FIGS. 1 and 2.

### DETAILED DESCRIPTION

Methods, systems, products and other features an improved enterprise level sales management system and method including real-time incentivization and compensation for tele-agents are described with reference to the accompanying drawings. Many products and services, including cloud- or web-based products and services, computing systems and other software products, industrial goods and commodities, et cetera, are increasingly being sold over the phone by tele-agents. Such sales are often for complex systems and to very sophisticated customers. These tele-agents are often able to modularize and customize products bringing increased efficiency and efficacy to their customers.

For example, cloud-based or web-services products are highly customizable and various products may be combined to provide the best solution for the customer and can be further customized based upon region or industry. Such cloud-based web services often include computing applications, database applications, migration applications, network and content delivery applications, business management tools, business analytics, artificial intelligence, mobile services, and many more applications.

A tele-agent, as this term is used in this specification, is a person who handles incoming or outgoing customer calls for business. Such tele-agents are often subject matter experts regarding the products that they sell and support and often work in call centers handling sales, inquiries, complaints, support issues, and other related sales and support operations. The term tele-agent, as it is used in this specification, is meant to be inclusive and not limiting. Other example names for a tele-agent include call center agent, customer service representative, telephone sales or service representative, attendant, associate, operator, account executive or team member.

As an aid to maximizing sales, tele-agents may be incentivized through real-time communications to follow protocols that are established by management based on a number of factors. Example factors for developing sales compensation plans may include commissionable events, credits, measures, goals, payments, balance carried forward, and, as described next, other incentives.

Various actions on the part of tele-agents may be instrumental in bolstering sales success. Such actions may include, among others, creating or updating an organization chart for a current or potential customer or client, making a periodic sales inventory call for a current customer or client, in particular for those with long sales cycles, and sending birthday or holiday cards or notes to points of contact within the customers' organizations. It is desirable to entice tele-agents to perform these and other productive actions on a regular basis so as to form good behaviors and habits, which may be accomplished by real-time tracking of desired sales-related actions and compensation for performing such actions. Real-time tracking of and compensation for desired sales-related actions incentivizes tele-agent productivity and rewards success.

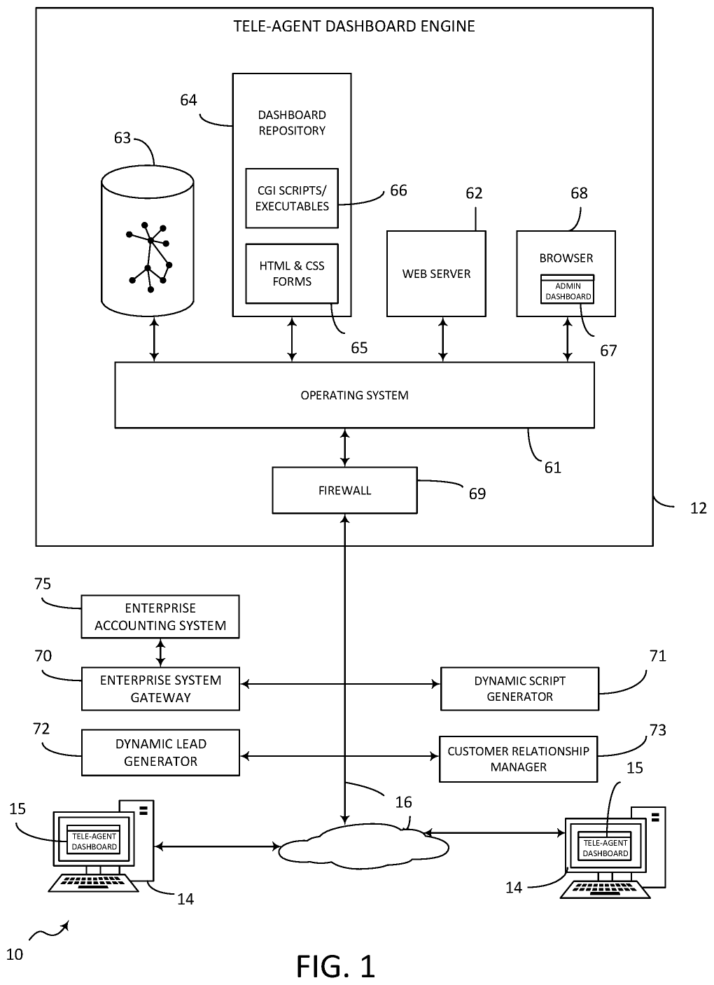

FIG. 1 is a block diagram of an improved enterprise level sales management system and method including real-time incentivization and compensation for tele-agents according to one or more embodiments. Referring to FIG. 1, the system is designated generally as enterprise sales management system 10. System 10 includes tele-agent dashboard engine 12, which is operatively coupled to one or more tele-agent stations 14. In one or more embodiments, tele-agent dashboard engine 12 is coupled to tele-agent stations 14 via an internet or other network connection 16. However, other methods or coupling tele-agent dashboard engine 12 to tele-agent stations 14 may be used as known to routineers in the art. Tele-agent dashboard engine 12 may be collocated with tele-agent stations 14, or may be remotely located as known in the art.

Tele-agent dashboard engine 12 is preferably a high-capacity web server that hosts one or more web server software applications for selectively and securely allowing one or more tele-agent stations 14 access over internet or other network 16 for transfer of hypertext markup language (HTML) files and the like. Tele-agent dashboard engine 12 preferably has the memory capacity and functional capabilities of at least a powerful desktop computer to support a large number of concurrent processes and maintain high-throughput communications, and more preferably still, is sufficiently capable to support several hundred concurrent client connections. As known in the art, tele-agent dashboard engine 12 may be equipped with a local display monitor and input keyboard, keypad, and/or input pointing device (not illustrated) for interfacing with a local system administrator.

As is well known in the computer field, tele-agent dashboard engine 12 preferably contains a processor which executes instructions retrieved from a memory device to control the reception and manipulation of input data, the transfer of data to other computers, and the output and display of data on output devices. Preferably, a memory bus is used by the processor to access random access memory (RAM), read only memory (ROM), or other memory. Memory is used for storing input data, processed data, and software in the form of instructions for the processor. The processor may be coupled to a peripheral bus to access input, output and storage devices, possibly including a display monitor, removable disc drive (e.g. CD-ROM), hard disk drive, input keyboard, mouse, universal serial bus (USB) device, and network interface. As this general computer technology is commonplace and well understood in the art, it is neither illustrated nor discussed further herein.

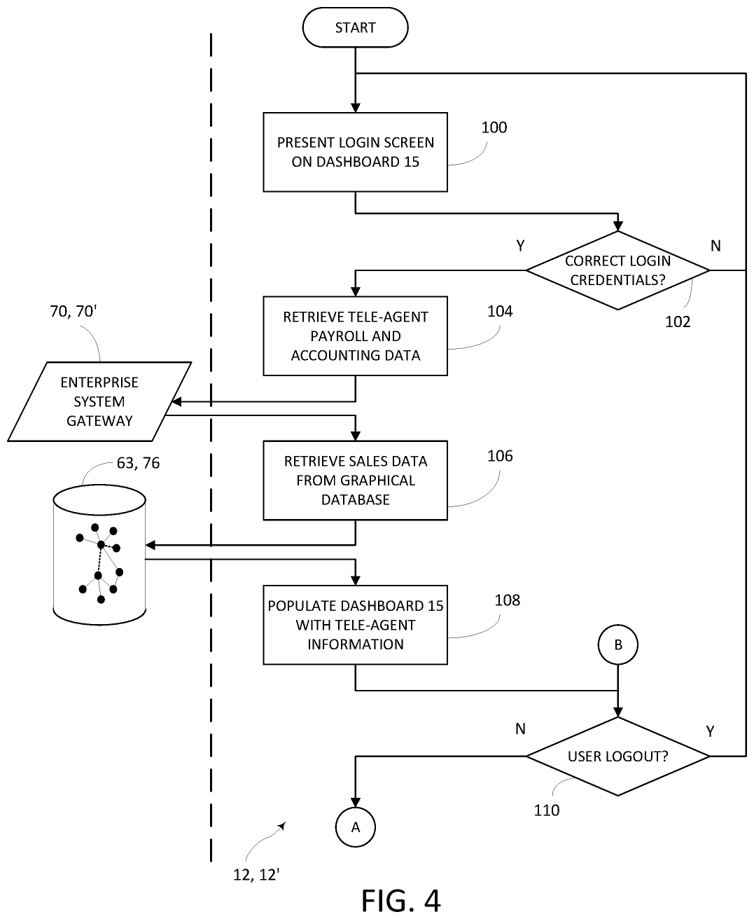

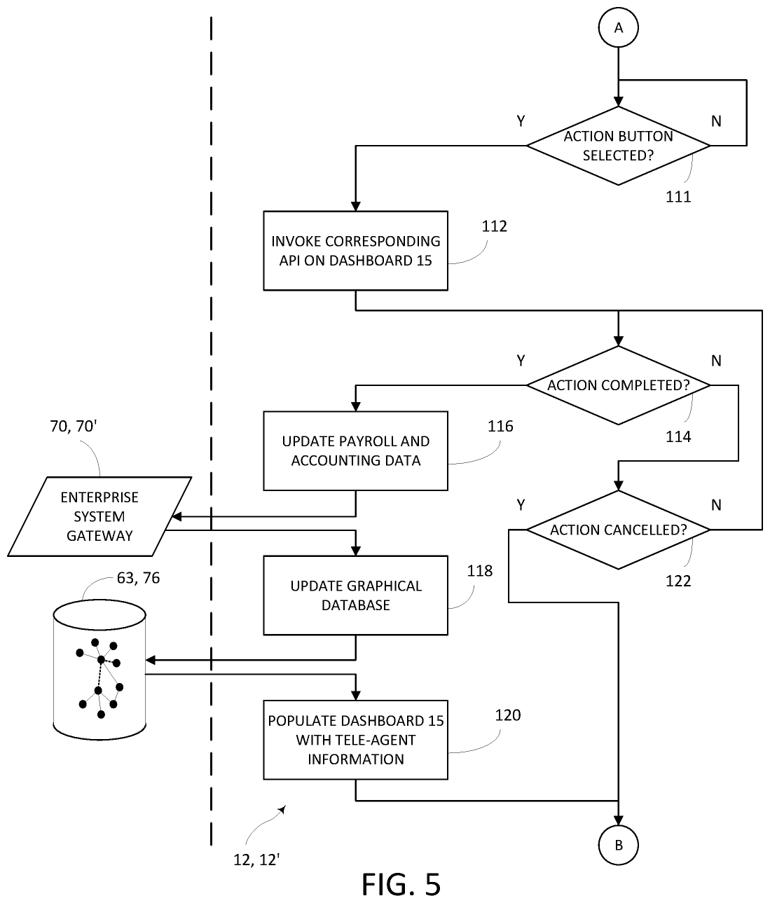

Tele-agent dashboard engine 12 includes computer software 60 as an integral part of the system. Computer software 60 may include an operating system (OS) 61, a web server application 62, a database 63, and a tele-agent dashboard repository 64—the custom code written to implement the algorithm of FIGS. 4 and 5. Software 60 may also include an optional web browser application 68, and an optional network firewall application 69. Computer software 60 may reside in RAM, ROM, hard disk drives, CD-ROMs, other storage media, or combinations thereof. Additionally, software 60 may be stored at a separate computer (not illustrated) and accessed over a network.

Operating system 61, which controls computer resources, peripherals, and the execution of software applications for tele-agent dashboard engine 12, is preferably an industry-standard multiuser multitasking web server OS such as an open source Linux® variant. Other appropriate operating systems may also be used. As OS technology is commonplace and well understood in the art, OS 60 is not discussed further herein.

Web sever application 62, which is often bundled with operating system 61, enables tele-agents at remote tele-agent stations 14 to access tele-agent dashboard engine 12 to efficiently perform and track various sales tasks and view in real-time compensation earned therefrom. Apache is a popular open source hypertext transport protocol (HTTP) web server application that is used with Linux,® Windows® and other operating systems. Utilizing standard ethernet and transmission control protocol/internet protocol (TCP/IP) networking techniques, tele-agent dashboard engine 12 is connected to internet or other network 16. With communications managed by web server application 62, tele-agent dashboard engine 12 is accessible via a static internet protocol (IP) address from computers having internet access located anywhere in the world. As web server applications are commonplace and well known in the art, web server application 62 is not discussed further herein.

Tele-agent dashboard engine 12 may store and manipulate historical, current and projected data associated with customers, potential customers, industries, inventories, product lines, accounting, and the like, as described in greater detail hereinafter. Accordingly, tele-agent dashboard engine 12 may include a database 63 in order to simplify the organization, analysis and handling of the large amount of data, as described in greater detail hereinafter. In one embodiment, tele-agent dashboard engine 12 also functions as a database server for database 63 in addition to its role as a web server. However, with a large number of concurrent client connections, to enhance scalability and performance it may be preferable to host database 63 on a dedicated database server (not illustrated), as understood by routineers in the art.

Database 63 is ideally implemented using graph database technology. A graph database is a database that uses graph structures for semantic queries with nodes, edges and properties to represent and store data in the form of semantic triples, as described in greater detail below. A key concept of this database system is the graph (or edge or relationship), which directly relates data items in the data store. The relationships allow data in the store to be linked together directly, and in many cases retrieved with one operation.

The graph database contrasts with conventional relational databases, in which data is organized in the form of tables. The relational data model consists of three components: A data structure wherein data are organized in the form of tables; means of data manipulation for manipulating data stored in the tables, e.g. structured query language (SQL); and means for ensuring data integrity in conformance with business rules. In the relationship database model, links between data are stored in the data, and queries search for this data within the store and use the join concept to collect the related data. On the other hand, graph databases, by design, allow simple and fast retrieval of complex hierarchical structures that are difficult to model in relational systems.

The underlying storage mechanism of graphical database 63 can vary. In one or more embodiments, it may depend on a relational engine and store the graph data in a table, while in other embodiments, it may use a key-value store or document-oriented scheme for storage, making it an inherently NoSQL structure. Retrieving data from graph database 63 ideally uses a query language other than SQL, which was designed for relational databases and does not elegantly handle traversing a graph. There are a number of languages, most often tightly tied to particular products, and there are some multi-vendor query languages like Gremlin, SPARQL, and Cypher that may be used to traverse graphical database 63. In addition to having a query language interface, graphical database 63 may be accessed through one or more particular application programming interfaces (APIs), as known to routineers in the art.

As noted above, graph database 63 is based on graph theory, and employs nodes, edges, and properties. Nodes represent entities such as people, businesses, accounts, or any other item to be tracked. They are roughly the equivalent of the record, relation, or row in a relational database, or the document in a document database. Edges, also termed graphs or relationships, are the lines that connect nodes to other nodes; they represent the relationship between them. Meaningful patterns may emerge when examining the connections and interconnections of nodes, properties, and edges. Edges are the key concept in graph database 63, representing an abstraction that is not directly implemented in conventional database systems. Properties are germane information that relate to nodes. For example, if N3 were one of the nodes, it might be tied to properties such as web-services support, cloud-computing, or a word that starts with the letter N, depending on which aspects of N3 are germane to a given database.

Database 63 is ideally is composed of semantic triples of a defined form of semantic logic, such as, for example, a predicate logic or a description logic, that includes all knowledge that is available to a tele-agent. A triple is a three-part statement expressed in a form of logic. Depending on context, different terminologies are used to refer to essentially the same three parts of a statement in a logic. In first order logic, the parts are called constant, unary predicate, and binary predicate. In the Web Ontology Language (OWL), the parts are individual, class, and property. In some description logics the parts are called individual, concept, and role. In this disclosure, the elements of a triple are referred to as subject, predicate, and object and expressed as: <subject> <predicate> <object>. There are many modes of expression for triples. Elements of triples can be represented as Uniform Resource Locaters (URLs), Uniform Resource Identifiers (URIs), or International Resource Identifiers (IRIs). Triples can also be expressed in N-Quads, Turtle syntax, TriG, Javascript Object Notation (JSON), and so on. The expression used here, <subject><predicate><object>, is a form of abstract syntax, optimized for human readability rather than machine processing, although its substantive content is correct for expression of triples. Using this abstract syntax, the following are examples of triples:

<Bob> <is a> <person>
<Bob> <is a friend of> <Alice>
<Bob> <is born on> <the 4th of July 1990>
<Bob> <is interested in> <the Mona Lisa>
<the Mona Lisa> <was created by> <Leonardo da Vinci>
<the video ‘La Joconde à Washington’> <is about> <the Mona Lisa>

The triples are semantic triples in the sense that such triples may have meanings defined by inferences, which may be expressly described in additional triples, referred to herein as inferred triples. Inferencing is a process by which new triples are systematically added to a graph based on patterns in existing triples. Information integration, inclusion of newly inferred triples, can be achieved by invoking inferencing before or during a query process. The following is an example of an inference rule:

| IF { <A> <is a subclass of> <B>} | |
|---|---|
| AND | { <x> <is of type> <A>} |
| THEN | { <x> <is of type> <B>} |

In plain language, the above exemplary inference rule says that if class A is a subclass of class B, anything of type A is also of type B. This rule is referred to as a type propagation rule. The underlying purpose of such inferencing is to create, by enterprise sales management system 10, data that are more connected, better integrated, and in which the consistency constraints on the data are expressed in the data itself, thereby improving the efficiency, functionality, and overall processing of the computer system itself by which enterprise sales management system 10 is implemented.

The same item can be referenced in multiple triples. In the above example, Bob is the subject of four triples, and the Mona Lisa is the subject of one triple and the object of two. This ability to have the same item be the subject of one triple and the object of another makes it possible to effect connections among triples, and connected triples form graphs.

The description of database 63 as a graph database is for explanation and not for limitation. In fact, alternative embodiments may include SQL databases, relational databases, NoSQL, or any other viable database structure that will occur to those of skill in the art.

Tele-agent dashboard engine 12, running web server application 62, functions by listening for connections made by authorized tele-agent stations 14 over internet or other network 16 and thereafter by transmitting selective data between tele-agent stations 14 and tele-agent dashboard engine 12. Tele-agent dashboard repository 64 is a suite of custom software programs and files that work hand-in-hand with web server application 62 to implement the incentive compensation method according to one or more embodiments. Tele-agent dashboard repository 64 and web server application 62 together generate interactive dynamic tele-agent dashboards 15, and optionally an administrator dashboard 67 that may accessed via web browser 68 or other networked browser for administration of tele-agent dashboard engine 12. Tele-agent dashboard repository 64 communicates with database 63 to store, access, and manipulate data as described below with respect to FIG. 4.

In one or more embodiments, tele-agent dashboard repository 64 preferably includes a family of HTML and cascading style sheet (CSS) form files 65 disposed in a web page directory accessed by web server application 62, and a series of Common Gateway Interface (CGI) shell scripts or compiled programs 66, disposed in a cgi-bin or like directory, that are selectively executed in order to transform the otherwise static HTML form files 65 into dynamic dashboards 15, 67 when displayed in web browsers. Java, PHP, Perl, BASH, and similar programming languages are commonly used in conjunction with HTML to add intelligent functionality to web sites, as known by routineers in the art,

The embodiments of enterprise sales management system 10 are not limited to the use of HTML and CSS coding; XML, PHP, Java, and/or other appropriate coding schemes, either extant or yet to be developed, may be used as known in the art. Moreover, although the embodiments of system 10 described herein may employ TCP/IP communication techniques, the present disclosure is not limited to using this format. New communication formats and protocols may be developed over time which may replace existing formats, and sales management system 10 preferably employs technologies consistent with the computing and communication standards in use at any given time.

Dashboards 15, 67 ideally employ standard windows-type display and control mechanisms including windows, client windows, frames, flexboxes, icons, buttons, check boxes, radio buttons, scroll bars, drop-down menus, pull-down menus, tabs, bar graphs, panes, panels, forms, slide bars, selection boxes, dialog boxes, text boxes, list boxes, menu bars, bar graphs, wizards, et cetera. The selection and layout of the user interface components, and the placement thereof, may vary widely within the scope of the present disclosure and may optionally be customized by each user. Ideally, dashboards 15, 67 employ responsive site design techniques so as to automatically adjust layout and design to be readable and usable at any screen width. As user interface programming and design are well known in the art, further detail is omitted.

Although tele-agent dashboard 15 has been described above as implemented using dynamic web pages displayed in a typical browsers on tele-agent stations 14, in other embodiments tele-agent dashboards 15 may be implemented, in part or in total, by executing custom compiled computer code residing locally on tele-agent stations 14. For instance, many commercial off-the-shelf browsers such as Edge,® Internet Explorer,® Chrome,® Firefox,® and Safari® allow integration with third party custom plug-ins, which may also be known as add-ons or extensions. Accordingly, in one or more embodiments, tele-agent dashboards 15 are produced by dynamic web files provided by tele-agent dashboard engine 12 in coordination with browsers and one or more plug-ins locally residing on tele-agent stations 14. In other embodiments, tele-agent dashboard engine 12 may communicated directly with custom software residing on tele-agent stations 14 via internet or other network 16 without the use of browsers and standard web page display schemes.

In one or more embodiments, web server application 62 and tele-agent dashboard repository 64 cooperate to provide secure remote internet access to tele-agent dashboard engine 12. Tele-agent dashboard engine 12 may provide initial login access to a remote client computer via an initial or default HTML file that prompts the user for a username and password or other identifier. A tele-agent may log into tele-agent station 14 and thereby obtain an instance of tele-agent dashboard 15 that is populated with his or her particular custom data.

Tele-agent dashboard engine 12 may include a network firewall 69 to protect it from unauthorized intrusion and computer hacking efforts. Firewall 69 may be a firewall software application executed by tele-agent dashboard engine 12 as illustrated, or it may be a discrete and independent hardware firewall (not illustrated) operatively coupled between tele-agent dashboard engine 12 and internet or other network 16. Regardless of the type of firewall 69 installed, firewall 69 is preferably commercial off-the-shelf and provides controlled access to tele-agent dashboard engine 12 using multiple recognized network security methods such as user and password challenges, virtual private network (VPN) access, filtered IP address access, et cetera. In other words, tele-agent dashboard engine 12 is secured to eliminate unauthorized access the same way that an ordinary computer is protected using existing or future common network security products. As network firewalls are well known in the art, further detailed discussion is omitted.

Tele-agent dashboard engine 12 may collect data for analysis, retrieve, store, organize, and process that data in real time, and may provide downloadable reports compatible with off-the-shelf software products such as Excel,® Word,® Access,® et cetera. Tele-agent dashboard engine 12 may generate and make available a myriad of reports from the collected data, allowing a tele-agent to query and format data and graphically display trends with tremendous flexibility, as described in greater detail below.

In one or more embodiments, sales management system 10 includes an enterprise system gateway 70. Enterprise system gateway 70 may be included as an integral part of tele-agent dashboard engine 12 (not illustrated) or as a separate computing machine operatively coupled with tele-agent dashboard engine 12 via internet or other network 16. Enterprise system gateway 70 provides an interface between sales management system 10 and the enterprise accounting system(s) 75 used by the company.

In one or more embodiments, enterprise system gateway 70 extracts and formats payroll data from the company's′ enterprise accounting system(s) 75 to display a tele-agent's current and historical compensation data, which may include commission and other incentive dollars earned year-to-date, quarter-to-date, month-to-date, week-to-date, pay-period-to-date, per annum, per month, or any other suitable period. Dollars earned may reflect and be selectively subdivided into salary base, commissionable sales, incentivized actions, credits, payments, and balance carried forward. Dashboard 15 may include controls that a tele-agent may manipulate that allows selection and custom formatting of payroll data.

Enterprise system gateway 70 also receives data from tele-agent dashboard engine 12 when a tele-agent performs an incentivized action, which is reformatted and manipulated as required to be accepted by the company's enterprise accounting system(s) 75. In this manner, incentive compensation displayed on tele-agent dashboard 15 may be updated in real-time.

In one or more embodiments, sales management system 10 includes a dynamic script generator 71 for tele-agents. Dynamic script generator 71 may be included as an integral part of tele-agent dashboard engine 12 (not illustrated) or as a separate computing machine operatively coupled with tele-agent dashboard engine 12 via internet or other network 16. Dynamic script generator 71 creates an on-call real-time dynamic script, which may be displayed on tele-agent dashboard 15 for a tele-agent to use during sales calls.

One desirable sales attribute of a tele-agent is a sound knowledge and understanding of a customer's or client's industry. Dynamic script generator 71 includes a statistics engine receive real-time industry trend data from one or more remote industry resources. Remote industry resources may include an analyst information repository, an agent result repository, and stock, commodities, and market trend data.

The analyst information repository, mentioned above, may be implemented as a repository or data store for storing, classifying, and analyzing analyst information. Such analyst information is typically the work product of one or more industry analysts and their respective staff. Typically, an industry analyst performs primary and secondary market research within an industry such as information technology, consulting or insurance, or other rapidly moving areas of industry. Analysts assess sector trends, create segment taxonomies, size markets, prepare forecasts, and develop industry models. Industry analysts often work for research and advisory services firms, and some analysts also perform advisory or consulting services. Analysts often specialize in a single industry segment or sub-segment, researching the broad development of the market, as well as publicly traded companies, equities, investments, commodities, or associated financial opportunities. For the purposes of this disclosure, the term industry analyst also includes broader analysts such as financial analysts and as such, analyst information as that term is used in this specification includes financial, operational, and other types of analyst information.

Analyst information may include white papers, analyst reports, industry reports, financial reports, blogs, news articles, news feeds, really simple syndication (RSS) feeds, podcasts, television and radio news broadcasts and their associated transcripts, and other relevant analyst information that will occur to those of skill in the art. Furthermore, analyst information according to one or more embodiments include not only the raw content of produced by the analyst, the analyst's staff or colleague but also metadata describing, explaining, or otherwise augmenting the content itself.

The agent result repository may also include industry trend data as documented by other tele-agents in recent relevant calls. During calls between various tele-agents and customers in a specific industry, a tele-agent may document industry trend data such as specific customers, specific products purchased by those customers, the reasons those customers were interested in those specific products, concerns about the industry expressed by those customers, and other industry trend data that will occur to those of skill in the art. This industry trend data may be documented in the form of industry trend notes made by various tele-agents on sales calls and made available to dynamic script generator 71.

Dynamic script generator 71 may retrieve, in real-time, industry trend data in stock markets and commodities markets worldwide relevant to a particular industry. Such industry trend data may include ancillary industries that support the industry in which a customer is currently engaged. The stock and commodities market data may be aggregated by industry, segment, region, stock market, and other parsed stock information as will occur to those of skill in the art.

A dynamic script generator which may be used in one or more embodiments is disclosed in U.S. Published Patent Application 2019/0080370, filed on Sep. 11, 2017, entitled “Dynamic Scripts for Tele-Agents,” which is incorporated herein by reference in its entirety. Although dynamic script generator 71 is useful for creating automated customized scripts for tele-agents to refer to during sales calls, because it contains consolidated repositories for relevant industry trend data, including analyst reports, articles, news reports, white papers and the like, dynamic script generator 71 may also employed within the scope of the present disclosure simply as an online library for tele-agents to access for review and study relevant industry trends while not actively conducting customer calls. Because dynamic script generator 71 is integrally tied within sales management system 10, tele-agent access to the repositories and data of dynamic script generator 71 may be readily tracked in real-time by tele-agent dashboard engine 12.

In one or more embodiments, sales management system 10 includes a dynamic lead generator 72 for tele-agents. Dynamic lead generator 72 may be included as an integral part of tele-agent dashboard engine 12 (not illustrated) or as a separate computing machine operatively coupled with tele-agent dashboard engine 12 via internet or other network 16. Dynamic lead generator 72 identifies near-term surges in product interest for a number of companies of a particular size within particular industries and regions of the world, which may be displayed on tele-agent dashboard 15 as a resource for a tele-agent to promote sales.

One desirable sales attribute of a tele-agent is a sound knowledge and understanding of the customers' or clients' particular product interests, as well as those of the customers' competitors. Dynamic lead generator 72 ideally includes a dynamic profiling module that is configured to query one or more external sales analytics engines and receive, in response to the query, sales information identifying external sales of products for a number of companies. A sales analytic engine is an engine, typically implemented by a server, providing external sales information about various companies. Such an external sales analytics engine may be provided by a third party vendor who gathers sales information from various companies and publishes that information to its clients. Such information identifying external sales may include types and quantities of products being sold, companies purchasing those products, the industry of companies purchasing products, the size of those companies, the region of the world in which the products are being sold, and so on as will occur to those of skill in the art.

The dynamic profiling module may also be configured to identify a near-term surge in product interest for a number of companies of a particular size in a particular industry in a particular region of the world based upon the internal and external sales information received via sales analytics as well as tele-agent dashboard 15. The dynamic profiling module is also configured to create a company profile of identified companies associated with the near-term surge. The company profile identifies companies of a particular industry and size and operating a particular region of the world and may be representative of companies purchasing products identified in the near-term surge in interest. Companies meeting the criteria of the company profile are considered more likely candidates to become customers of the product represented by the identified surge in interest.

A dynamic lead generator which may be used in one or more embodiments is disclosed in U.S. Published Patent Application 2019/0188617, filed on Dec. 15, 2017, entitled “Dynamic Lead Generation,” which is incorporated herein by reference in its entirety. Although dynamic lead generator 72 is useful for potential leads for tele-agents, because it contains additional consolidated details about the players within a particular industry subset beyond the generalized industry data provided by dynamic script generator 71, dynamic lead generator 72 may also employed within the scope of the present disclosure simply as an online library for tele-agents to access to review and study relevant real-time and projected industry data while not actively conducting customer calls. Because dynamic lead generator 72 is integrally tied within sales management system 10, tele-agent access to the repositories and data of dynamic lead generator 72 may be readily tracked in real-time by tele-agent dashboard engine 12.

In one or more embodiments, sales management system 10 includes a customer relationship manager 73 for tele-agents. Customer relationship manager 73 may be included as an integral part of tele-agent dashboard engine 12 (not illustrated) or as a separate computing machine operatively coupled with tele-agent dashboard engine 12 via internet or other network 16. Customer relationship manager 73 implements data analysis of customers' or clients' histories with the company to improve business relationships, specifically focusing on retention and sales growth. Through customer relationship manager 73 and systems used to facilitate it, the business may learn more about its target audiences and how to best address their needs. Various functions of customer relationship manager 73 may be displayed and manipulated on tele-agent dashboard 15, which a tele-agent may use to promote sales.

One desirable sales attribute of a tele-agent is an intimate knowledge and understanding of the customers' or clients' employees, including buyers, purchasing managers, engineers, research and development (R&D) personnel, management, and the like. Customer relationship manager 73 allows tele-agents to review this data prior to and during calls with customers and to add or update this data during or after customer calls. For example, tele-agents may use customer relationship manager 73 to create or update customer organizational charts or to determine or record birthdays, promotion anniversaries, and other commemorative dates for personnel within a customer's organization, for sending personal notes or the like.

Customer relationship manager 73 ideally compiles data from a range of communication channels, including telephone, email, live chat, text messaging, marketing materials, websites, and social media. Customer relationship manager 73 may implement data warehouse technology, used to aggregate transaction information, to merge the information with information regarding products and services, and to provide key performance indicators. Customer relationship manager 73 aids managing volatile growth and demand and implementing forecasting models that integrate sales history with sales projections. Customer relationship manager 73 may track and measure marketing campaigns over multiple networks, tracking customer analysis by customer clicks and sales, for example.

A customer relationship manager that may be used in one or more embodiments is disclosed in U.S. patent application Ser. No. 16/198,742, filed on Nov. 21, 2018, entitled “Semantic CRM Transcripts from Mobile Communication Sessions,” which is incorporated herein by reference in its entirety. Because customer relationship manager 73 is integrally tied within sales management system 10, tele-agent access thereto, including actions such as adding or updating organization charts or reviewing customer social media accounts, may be readily tracked in real-time by tele-agent dashboard engine 12.

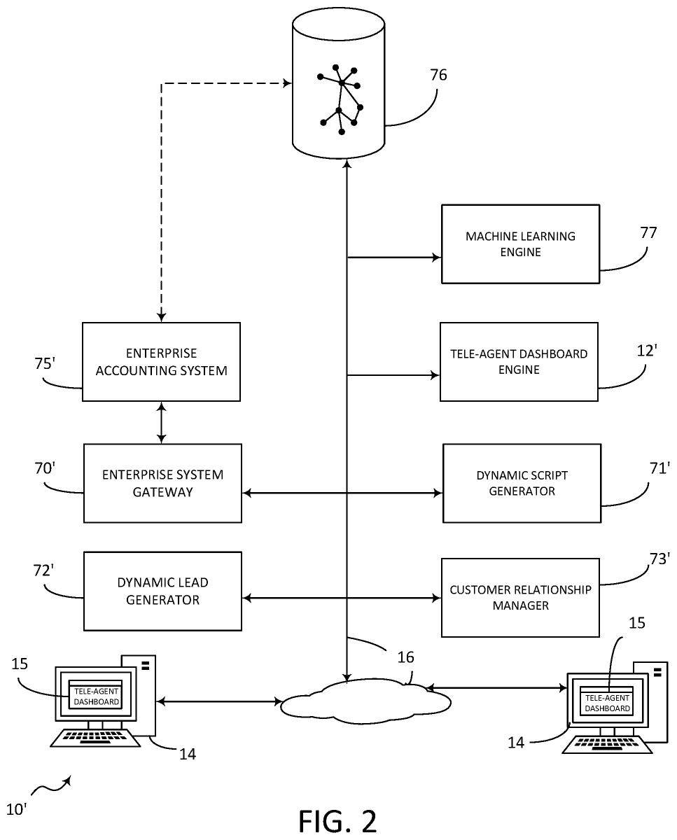

FIG. 2 is a block diagram of an sales management system 10′ according to one or more embodiments. System 10′ is substantially the same as sales management system 10 of FIG. 1, except that rather than having individual databases, tele-agent dashboard engine 12′ and optional dynamic script generator 71′, dynamic lead generator 72′, and customer relationship manager 73′ all share a common enterprise level graphical database 76. Additionally, enterprise accounting system 75′ may also share enterprise level graphical database 76. With these noted exceptions, components labeled with prime reference numbers in FIG. 2 are substantially identical to the corresponding un-primed components of FIG. 1.

Enterprise level graphical database 76 may include all or most information describing, pertinent to, or useful in an entire corporate enterprise: Financial records, business entities and structures, employee data, incorporation data, transactions, contracts, sales history, product descriptions, and so on. Incentive compensation data, as well as data associated with dynamic script generator 71′, dynamic lead generator 72′, and customer relationship manager 73′, are subsets of overall corporate information and accordingly may constitute subgraphs within enterprise level graphical database 76. In contrast, in the embodiments illustrated in FIG. 1, these data are represented in separate graphs rather than subgraphs of enterprise level graphical database 76. The present description of triples as subgraphs of an overall enterprise knowledge graph is for explanation rather than limitation.

System 10′ of FIG. 2 may be particularly preferred because enterprise level graphical database 76 facilitates a machine learning engine 77 to traverse graphical database 76, analyzing the nodes, edges, and properties of the graph database to provide valuable insight from the data. Machine learning engine 77 may be implemented as automated computing machinery configured for machine learning against graphical database 76.

Machine learning is closely related to (and often overlaps with) computational statistics, which also focuses on prediction-making through the use of computers. Machine learning has strong ties to mathematical optimization, which delivers methods, theory and application domains to the field. Machine learning is sometimes conflated or equated with data mining, where the latter subfield focuses more on exploratory data analysis and is sometimes known as unsupervised learning.

Within the field of data analytics, machine learning is a method used to devise complex models and algorithms that lend themselves to prediction; in commercial use, this is known as predictive analytics. These analytical models allow researchers, data scientists, engineers, and analysts to produce reliable, repeatable decisions and results and uncover hidden insights through learning from historical relationships and trends in the data.

Machine learning engine 77 improves the efficiency and operation of the overall computer architecture that implements sales management system 10′ and enterprise accounting system 75′. Machine learning engine traverses all of the nodes, edges, and properties defined by the triples in enterprise graphical database 76, inferring semantic triples according to various inference rulesets and performing other desired machine algorithms at each node. Traversal may occur using depth first recursive searching, breadth first searching or other suitable algorithms, such as by Diijstra's or Prim's rule. In addition to enabling predictive data analytics to uncover hidden insights through learning from historical relationships and trends in the data, machine learning engine 77 traversing enterprise graphical database 76 is believed to improve the overall processing of computer systems running enterprise-level business systems, thereby creating increased flexibility, faster search times, and smaller memory requirements.

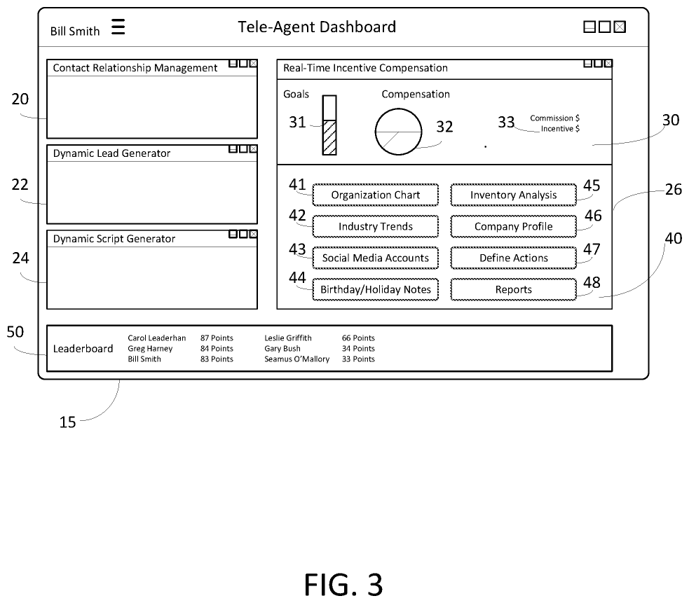

FIG. 3 is an elevation view of an exemplary tele-agent dashboard 15 of sales management system 10 of FIG. 1 and sales management system 10′ of FIG. 2 according to one or more embodiments. Referring to FIG. 3, dashboard 15 ideally employs standard windows-type display and control mechanisms including windows, client windows, frames, flexboxes, icons, buttons, check boxes, radio buttons, scroll bars, drop-down menus, pull-down menus, tabs, bar graphs, panes, panels, forms, slide bars, selection boxes, dialog boxes, text boxes, list boxes, menu bars, bar graphs, wizards, et cetera. The selection and layout of the user interface components, and the placement thereof, may vary widely within the scope of the present disclosure and may optionally be customized by each user. Ideally, dashboard 15 employs responsive site design techniques so as to automatically adjust layout and design to be readable and usable at any screen width. As user interface programming and design are well known in the art, further detail is omitted.

Dashboard 15 ideally includes various interface regions or windows for the tele-agent to access various functions. These windows may be resized, minimized, maximized, and positioned within dashboard as desired by the tele-agent. For instance, FIG. 3 illustrates a tele-agent dashboard 15 that is customized and populated with data for a tele-agent named Bill Smith. Dashboard 15 has four windows open: Contact relationship management window 20, dynamic lead generator window 22, dynamic script generator window 24, and real-time incentive compensation window 26.

Contact relationship management window 20 provides interaction with customer relationship manager 73, 73′ (FIGS. 1, 2), and may be populated with data, controls, and functionality as disclosed in U.S. patent application Ser. No. 16/198,742, filed on Nov. 21, 2018, entitled “Semantic CRM Transcripts from Mobile Communication Sessions,” which is incorporated herein by reference in its entirety. Dynamic lead generator window 22 provides interaction with dynamic lead generator 72, 72′ (FIGS. 1, 2), and may be populated with data, controls, and functionality as disclosed in U.S. Published Patent Application 2019/0188617, filed on Dec. 15, 2017, entitled “Dynamic Lead Generation,” which is incorporated herein by reference in its entirety. Similarly, dynamic script generator window 24 provides interaction with dynamic script generator 71, 71′ (FIGS. 1, 2), and may be populated with data, controls, and functionality as disclosed in U.S. Published Patent Application 2019/0080370, filed on Sep. 11, 2017, entitled “Dynamic Scripts for Tele-Agents,” which is incorporated herein by reference in its entirety.

Real-time incentive compensation window 26 may include a compensation dialog region 30 for display of real-time tele-agent compensation data. Data employed within compensation dialog region 30 may be supplied by enterprise accounting system(s) 75, 75′ via enterprise system gateway 70 to tele-agent dashboard engine 12, 12′ for display on tele-agent dashboard 15 (FIGS. 1, 2, respectively).

Compensation dialog region 30 may include various indicia and controls, which may optionally be determined and arranged by the tele-agent. Indicia may include one or more visual graph bars 31 that indicate the percentage complete of reaching given compensation goals set by the tele-agent and/or management, for example. Graph bars may indicate in real-time daily performance, weekly performance, or performance over one or more other periods of time. Graph bars 31 may indicate compensation performance for one or more particular measures or types of compensation, such as total compensation, commissions, or compensation earned for particular tasks or actions as designated by management.

Other indicia that may be displayed within compensation dialog region 30 may include pie charts 32 or other graphical elements. Pie charts 32 may be used to break down in real-time total compensation earned by type, such as commissions and various tasks or actions performed. Pie charts 32 may also be used to break down compensation per client or customer, industry, region, time period, et cetera.

Compensation dialog region 30 may also include textual indicia 33 that may display real-time numerical data such as total compensation, commissions, or other incentive compensation earned in a given day, week, pay period, month, quarter, year, year-to-date, quarter-to-date, month-to-date, pay-period-to-date, week-to-date, that day, or over a custom date-period.

Real-time incentive compensation window 26 may also include a tele-agent action region 40 for display and selection of various incentive-compensated tasks and actions as well as other housekeeping chores. For example, the exemplary tele-agent action region 40 of FIG. 3 includes the following action buttons: Organization chart 41, industry trends 42, social media accounts 43, birthday/holiday notes 44, inventory analysis 45, and company profile 46.

Organization chart action button 41 preferably launches a graphical application interface on tele-agent dashboard 15 that displays and allows editing of an extent organization chart for a given client or customer, or allow a new organization chart to be created by the tele-agent if one does not yet exist. Such graphical application interfaces are known by routineers in the art and may preferably be implemented using a browser plug-in.

In one embodiment, the organization chart is stored as semantic triples within graphical database 63 of incentivization engine 63 (FIG. 1). In other embodiments, the organizational chart is stored as semantic triples within a graphical database of dynamic lead generator 72 (FIG. 1) or within a graphical database of customer relationship manager 73 (FIG. 1). In yet another embodiment, as illustrated in FIG. 2, organization charts are stored as semantic triples within enterprise level graphical database 76.

As outlined with respect to FIGS. 4 and 5, infra, when a tele-agent reviews, updates, or adds an organization chart for a given client or customer, tele-agent dashboard engine 12 may update graphical database 63 (FIG. 1), or enterprise level graphical database 76 (FIG. 2), to reflect the tele-agent action and update enterprise accounting system(s) 75, 75′ via enterprise system gateway 70 (FIGS. 1, 2, respectively) to reflect this incentivized action.

In one or more embodiments, tele-agent selection of industry trends action button 42 launches a dialog box or window within tele-agent dashboard 15 that presents to the tele-agent selected relevant industry trend data, including analyst reports, articles, news reports, white papers and the like. The tele-agent may also be allowed to add pertinent notes to the repository based on calls made to and input received from customers and clients. Alternatively, such client feedback may be entered by tele-agents via contact relationship management window 20 via customer relationship manager 73, 73′ (FIGS. 1, 2), as disclosed in U.S. patent application Ser. No. 16/198,742, filed on Nov. 21, 2018, entitled “Semantic CRM Transcripts from Mobile Communication Sessions,” which is incorporated herein by reference in its entirety. Regardless, as illustrated in FIGS. 4 and 5, the tele-agent actions of reviewing or updating relevant industry trend data is recorded by tele-agent dashboard engine 12 within graphical database 63 (FIG. 1) or enterprise level graphical database 76 (FIG. 2), to reflect the tele-agent action, and enterprise accounting system(s) 75, 75′ via enterprise system gateway 70 (FIGS. 1, 2) is updated to reflect the incentivized action.

In one or more embodiments, company profiles created by dynamic lead generator 72, 72′ or inherently included as data compiled by customer relationship manager 73, 73′ (FIGS. 1, 2, respectively) includes links to and data extracted from customer or client social media sites and feeds. Tele-agent selection of social media accounts action button 43 launches a dialog box or window within tele-agent dashboard 15 that presents to the tele-agent selected particular customer social media data for review and/or comment. The tele-agent actions of reviewing or commenting on client social media is recorded by tele-agent dashboard engine 12 within graphical database 63 (FIG. 1) or enterprise level graphical database 76 (FIG. 2), to reflect the tele-agent action, and enterprise accounting system(s) 75, 75′ via enterprise system gateway 70 (FIGS. 1, 2) is updated to reflect the incentivized action.

Birthday/holiday notes action button 44, in one or more embodiments, may be used to generate and/or send personalized notes or cards to contacts of interest to the tele-agent and/or company, and to track such incentivized actions for compensation. Typical suitable dates may include various holidays, birthdays, anniversaries, and the like. In some embodiments, as shown in FIG. 1, these dates are preferably stored in graphical database 63 of tele-agent dashboard engine 12, within individual graphical databases of dynamic script generator 71, dynamic lead generator 72, or customer relationship manager 73, or a combination thereof. In other embodiments, as shown in FIG. 2, notable dates are stored in enterprise level graphical database 76.

Regardless, activation of birthday/holiday notes action button 44 may direct tele-agent dashboard engine 12, 12′ to query the appropriate database(s) to retrieve upcoming dates, which may be filtered and/or sorted by date range, occasion, customer, industry, region, position, and/or other criteria. In one or more embodiments, tele-agent dashboard engine 12, 12′ may launch an application interface that allows the tele-agent to draft messages, notes or cards, which may be automatically sent via email, text messaging, or push messaging by tele-agent dashboard engine 12, 12′ to the email addresses, cellular telephone numbers, or computer IP addresses on record for the contacts. Electronic cards may be sent, or physical cards may be printed and/or addressed by tele-agent dashboard engine 12, 12′ for delivery by post. Accordingly, tele-agent dashboard engine 12, 12′ is preferably equipped with or coupled to systems for emailing, text messaging, push messaging, printing, et cetera, as known to routineers in the art. As before, tele-agent dashboard engine 12, 12′ records the tele-agent actions within graphical database 63 (FIG. 1) or enterprise level graphical database 76 (FIG. 2), to reflect the tele-agent action, and enterprise accounting system(s) 75, 75′ via enterprise system gateway 70 (FIGS. 1, 2) is updated to reflect the incentivized action.

Customers and clients with long sales, production, or design cycles may particularly benefit from periodic sales inventory calls. Inventory analysis action button 45 preferably launches an application interface or dialog box that displays historical sales data for a particular customer, analysis defining inventory levels historically maintained by the customer or inventory requirements expressly conveyed by the customer, projections for upcoming inventory requirements, open, pending and standing orders, backorders, and the like. Such application interfaces are known by routineers in the art. This data may be gathered, analyzed and formatted by tele-agent dashboard engine 12, 12′ from graphical database 63 (FIG. 1) or enterprise level graphical database 76 (FIG. 2) for display in the application interface or dialog box.

The tele-agent may review requirements with the customer, updating the inventory requirements data and placing orders as appropriate. Tele-agent dashboard engine 12, 12′ records the tele-agent actions related to conducting inventory analysis within graphical database 63 (FIG. 1) or enterprise level graphical database 76 (FIG. 2) to reflect the tele-agent action, and enterprise accounting system(s) 75, 75′ via enterprise system gateway 70 (FIGS. 1, 2) is updated to reflect the incentivized action.

One desirable sales attribute of a tele-agent is a sound knowledge and understanding of the customers' or clients' particular product interests, as well as those of the customers' competitors. As described, supra, dynamic lead generator 72, 72′ ideally includes a dynamic profiling module that is configured to query one or more external sales analytics engines and receive, in response to the query, sales information identifying external sales of products for a number of companies. The dynamic profiling module is also configured to create a company profile, which identifies companies of a particular industry and size and operating a particular region of the world. Dynamic lead generator 72, 72′ is useful for potential leads for tele-agents, because it contains additional consolidated details about the players within a particular industry subset beyond the generalized industry data provided by dynamic script generator 71, 71′ and as an online library for tele-agents to access to review and study relevant real-time and projected industry data.

Company profile action button 44, in one or more embodiments, may be used to launch an application interface or dialog box that displays company profile data for a particular industry subset for review by the tele-agent, and to track such incentivized action for compensation. In some embodiments, as shown in FIG. 1, these company profile data are preferably stored in graphical database 63 of tele-agent dashboard engine 12, within individual graphical databases of dynamic lead generator 72, or a combination thereof. In other embodiments, as shown in FIG. 2, company profile data are stored in enterprise level graphical database 76. Tele-agent dashboard engine 12, 12′ records the tele-agent actions of reviewing company profile data within graphical database 63 (FIG. 1) or enterprise level graphical database 76 (FIG. 2), to reflect the tele-agent action, and enterprise accounting system(s) 75, 75′ via enterprise system gateway 70 (FIGS. 1, 2) is updated to reflect the incentivized action.

All of the above-described examples of incentivized tele-agent actions are merely possible examples of implementations that may be made following the principles of the disclosure. Managers for a particular establishment may accordingly define other actions that they wish to track and compensate. Accordingly, real-time incentive compensation window 26 may also include a define actions button 47, that allows addition, modification, or deletion of incentivized actions and their associated rulesets. Define actions button 47, in one or more embodiments, may be used to launch an application interface or dialog box that allows creation, deletion, and customization of compensated tele-agent actions.

Within the environment of tele-agent dashboard 15, define actions button 47 may have limited functionality, because a tele-agent may lack permissions necessary to modify all parameters of incentivized compensation. However, a tele-agent may have certain permissions, as allowed by management, to set reminders, define certain customer or client groups, set filters, and other similar parameters.

Define actions button 47 may allow input of superuser or management credentials to unlock total functionality, such as adjusting rulesets, compensation rates and limits, defining new actions, and so forth as will occur to routineers in the art. Additionally, define actions button 47 may also be included in administrator dashboard 67 (FIG. 1) to allow managers access to set global incentive compensation parameters.

Tele-agent dashboard 15 may also include a leaderboard display 50, which may display performance rankings of a number of tele-agents to bolster friendly competition among coworkers. The performance rankings may be based upon particular actions performed, incentive compensation earned in a competition period, conversion of leads, or any other suitable metric as may be determined by management. Tele-agent dashboard engine 12, 12′ may operate to update leaderboard display 50 in real time as the statistics change.

FIGS. 4 and 5 are simplified flow chart diagrams that outline a method for improving the efficiency of an enterprise sales management system according to one or more embodiments. These figures employ a standard flow chart convention where decisions are represented by a rhomboidal symbol and actions are represented by a rectangular symbol. The program logic flow between the various decisions and actions is depicted by single-lined arrows. For instance, each decision rhombus contains an interrogatory. If the interrogatory, when evaluated, is true or yes, the program flow is indicated by the arrow leading from that rhombus designated with a “Y.” Likewise, if the interrogatory is false or no, the program flow is indicated by the arrow leading from that rhombus labeled with an “N.” The right-hand side of FIGS. 4 and 5 illustrate basic logic employed by tele-agent dashboard engine 12, 12′ according to one or more embodiments.

Referring first to FIG. 4, at step 100, tele-agent dashboard engine 12, 12′ may present initial login access to a remote client computer via an initial or default HTML file that prompts the user for a username and password or other identifier. At step 102, a tele-agent may enter login credentials into the system. If incorrect credentials are entered, program flow returns to step 100 and the login screen is refreshed, ideally with notification that an incorrect username or password was provided, for example. Tele-agent dashboard engine 12, 12′ may lock out further attempts for a time if three or more unsuccessful attempt are made in a row to attempt to gain access to the system.

Provided the login credentials are correct, tele-agent dashboard engine 12, 12′ generates an instance of tele-agent dashboard 15 that is populated with the tele-agent's particular custom data. At step 104, tele-agent dashboard engine 12, 12′ pulls payroll and sales accounting data from enterprise accounting system 75, 75′ (FIGS. 1, 2) via enterprise system gateway 70, 70′, which executes any necessary data conversions and calculations for the two systems to work together. At step 106, any sales or other data not contained in enterprise accounting system 75, 75′ that is necessary to populate dashboard 15 is retrieved from graphical database 63, 76. Such data may include custom dashboard profile settings as well as customer relationship data, industry data, et cetera generated by customer relationship manager 73, 73′, dynamic script generator 71, 71′, and dynamic lead generator 72, 72′.

With accounting and other sales data collected, at step 108 tele-agent dashboard engine 12, 12′ generates the instance of dashboard 15, populated with the tele-agent's particular data. As discussed previously, dashboard 15 may be created using dynamic web pages, browser plug-ins, or a combination thereof. In the case of a browser-less embodiment, tele-agent dashboard engine 12, 12′ simply coordinates with the stand-along executable program running on the tele-agent station 14 (FIGS. 1, 2) to communicate the requisite data.

At this stage, tele-agent dashboard engine 12, 12′ simply enters a holding pattern, awaiting further instruction from the tele-agent. One such instruction, illustrated at step 110, may be the tele-agent logging off dashboard 15. User logout may occur as a result of the tele-agent expressly selecting a logout button on dashboard 15, by interruption of the connectivity of tele-agent dashboard engine 12, 12′ with the browser or other software running on tele-agent station 14 (FIGS. 1, 2), due to loss of internet or other network 16 (FIGS. 1, 2), or after a prolonged period of inactivity, for example. If a logout condition is indicated at step 110, program flow returns to step 100 to present a login screen again. If logout condition is not indicated, tele-agent dashboard engine 12, 12′ continues to wait for further tele-agent instruction. as indicated by step 111 (FIG. 5).

Referring now to FIG. 5, when the tele-agent selects an action button, at step 112 tele-agent dashboard engine 12, 12′ will take any number of particular steps depending on which action button has been selected. For brevity, the flow chart of FIG. 5 illustrates that tele-agent dashboard engine 12, 12′ will invoke a API that corresponds to the action button selected. For example, tele-agent dashboard engine 12, 12′ may launch a graphical interface that allows the tele-agent to create or update an organization chart upon selection of organization chart action button 41 (FIG. 3). In actuality, however, not all possible actions may require an API; that is, for some actions tele-agent dashboard engine 12, 12′ may directly perform the steps required to enable the tele-agent to perform the given action and to track its successful completion.

Regardless of the particular means by which step 112 is carried out, tele-agent dashboard engine 12, 12′ next enters another holding pattern at steps 114 and 122, awaiting completion of the action. If at step 114 the action has not been completed, at step 122 it is assessed whether the tele-agent cancelled the action, such as by selecting a cancel button presented by the API of step 112. If the action has not yet been cancelled, program flow loops back to step 114. If the action has been cancelled, program flow returns to the first holding pattern reflected by steps 110 and 111 of assessing a logout condition and waiting for an action button to be selected by the tele-agent. Although the flowcharts of FIGS. 4 and 5 illustrate a simplified sequential flow of completing one action before initiating another, one skilled in the art will recognize that tele-agent dashboard engine 12, 12′ may be made to accommodate multiple concurrent actions, as such interrupt-style multitasking software programming in known in the art.

Once the tele-agent action has been successfully completed, program flow moves to step 116, where tele-agent dashboard engine 12, 12′ updates payroll and accounting data of enterprise accounting system 75, 75′ via enterprise system gateway 70, 70′ to reflect incentive pay earned by the tele-agent for completing the action. Additionally, the leaderboard display 50 (FIG. 3) on all running instances of tele-agent dashboard 15 may be updated as appropriate.

In the embodiments of FIG. 1, at step 118, database 63 of tele-agent dashboard engine 12, and/or one or more of the local databases of customer relationship manager 73, dynamic lead generator 72, or dynamic script generator 71, as appropriate, is updated with any appropriate data resulting from performance of step 112. Furthermore, tele-agent dashboard engine 12 may use this opportunity to traverse the graph data to infer any new semantic triples and perform any other machine learning algorithms. Likewise, in the embodiment of FIG. 2, tele-agent dashboard engine 12′ may update enterprise level graphical database 76 with any appropriate data resulting from performance of step 112 and may invoke machine learning engine 77 to traverse the graph data to infer any new semantic triples are perform any other machine learning algorithms.

Finally, at step 120, tele-agent dashboard is updated to reflect the new incentive compensation earned and goal status, et cetera, and program flow returns to the first holding pattern reflected by steps 110 and 111 of assessing a logout condition and waiting for an action button to be selected by the tele-agent.

FIGS. 1-5 illustrate the architecture, functionality, and operation of possible implementations of systems, methods and products according to various embodiments of the present disclosure. In this regard, each block in a flowchart or block diagram may represent a module, segment, or portion of code or other automated computing machinery, which comprises one or more executable instructions or logic blocks for implementing the specified logical function(s). It should also be noted that, in some alternative implementations, the functions noted in the block may occur out of the order noted in the figures. For example, two blocks shown before or after one another may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Automated computing machinery as that term is used in this specification means a module, segment, or portion of code or other automated computing logic, hardware, software, firmware, and others, as well as combination of any of the aforementioned, as will occur to those of skill in the art—both local and remote. Automated computing machinery is often implemented as executable instructions, physical units, or other computing logic for implementing the specified logical function(s) as will occur to those of skill in the art.

The Abstract of the disclosure is solely for providing the a way by which to determine quickly from a cursory reading the nature and gist of technical disclosure, and it represents solely one or more embodiments.

The above-described embodiments of the present disclosure are merely possible examples of implementations set forth for a clear understanding of the principles of the disclosure. Variations and modifications may be made to the above-described embodiment(s) without departing substantially from the spirit and principles of the disclosure. All such modifications and variations are intended to be included herein within the scope of this disclosure and protected by the following claims.

What is claimed is:

1. In an enterprise sales management system in communication with a computer-hosted accounting system, the improvement comprising:
a graphical database designed and arranged for storing data in the form of triples defining a plurality of interconnected nodes, edges, and properties;
a customer relationship manager implemented by automated computing machinery coupled to the graphical database; said customer relationship manager designed and arranged to collect, organize and display data reflecting interaction with a contact and to store said data in said graphical database;
a dynamic lead generator implemented by said automated computing machinery operatively coupled to the graphical database, said dynamic lead generator designed and arranged to query an external sales analytics engine and to produce a company profile therefrom that identifies products of interest for a particular plurality of companies and to store the company profile in said graphical database;
a dynamic script generator implemented by said automated computing machinery operatively coupled to the graphical database, said dynamic script generator designed and arranged to query a plurality of remote industry resources and collect industry trend information and to store said industry trend information in said graphical database;
a machine learning engine implemented by said automated computing machinery operatively coupled to the graphical database, said machine learning engine designed and arranged to iteratively traverse said graphical database and apply semantic reasoning at each of said plurality of interconnected nodes; and
a tele-agent dashboard engine implemented by said automated computing machinery operatively coupled to said graphical database, said customer relationship manager, said dynamic lead generator, and said dynamic script generator, said tele-agent dashboard engine operatively coupled by an enterprise system gateway to said accounting system for reading and posting payroll data, said tele-agent dashboard engine designed and arranged to generate a tele-agent dashboard including,
one or more compensation indicia disposed on said dashboard and reflecting in real-time compensation earned by a tele-agent,
a customer relationship management interface region disposed on the dashboard and designed and arranged to collect, organize and display information and collect data reflecting interaction with a contact on said dashboard,
a dynamic lead generator interface region disposed on the dashboard and designed and arranged to display information from said company profile on said dashboard,
a dynamic script generator interface region disposed on the dashboard and designed and arranged to display said industry trend information on said dashboard, and
at least one action button disposed on said dashboard, said action button operable to cause said tele-agent dashboard engine to track an action performed by said tele-agent, to update said accounting system to reflect compensation earned by said tele-agent for performance of said action, and to update said one or more compensation indicia; whereby
said tele-agent dashboard engine and said tele-agent dashboard provide an enhanced, efficient user interface of said enterprise sales management system; and
said a machine learning engine and said graphical database cooperate to improve the overall processing efficiency of said automated computing machinery.

2. In an enterprise sales management system in communication with a computer-hosted accounting system, the improvement comprising:
a tele-agent dashboard engine implemented by said automated computing machinery and operatively coupled to said accounting system for reading and posting payroll data; and
a tele-agent dashboard generated by said tele-agent dashboard engine, said dashboard including,
one or more compensation indicia disposed on said dashboard and reflecting in real-time compensation earned by a tele-agent, and
at least one action button disposed on said dashboard, said action button operable to cause said tele-agent dashboard engine to track an action performed by said tele-agent, to update said accounting system to reflect compensation earned by said tele-agent for performance of said action, and to update said one or more compensation indicia; whereby
said tele-agent dashboard engine and said tele-agent dashboard provide an enhanced, efficient user interface of said enterprise sales management system.

3. The enterprise sales management system of claim 2 further comprising:
a customer relationship manager operatively coupled to the tele-agent dashboard engine, said customer relationship manager designed and arranged to collect, organize, display, and store data reflecting interaction with a contact; and
a customer relationship management interface region disposed on the dashboard operatively coupled to said customer relationship manager.

4. The enterprise sales management system of claim 3 wherein:
said action comprises one from the group consisting of creating, updating or reviewing a customer organizational chart, documenting a customer note, reviewing a customer social media account, sending a customer note or card, and conducting a customer inventory analysis.

5. The enterprise sales management system of claim 2 further comprising:
a dynamic lead generator operatively coupled to the tele-agent dashboard engine, said dynamic lead generator designed and arranged to query an external sales analytics engine and to produce a company profile therefrom that identifies products of interest for a particular plurality of companies; and
a dynamic lead generator interface region disposed on the dashboard operatively coupled to said dynamic lead generator and designed and arranged to display information from said company profile; wherein
said action consists of reviewing said information from said company profile.

6. The enterprise sales management system of claim 2 further comprising:
a dynamic script generator operatively coupled to the tele-agent dashboard engine, said dynamic script generator designed and arranged to query a plurality of remote industry resources and collect industry trend information; and
a dynamic script generator interface region disposed on the dashboard and designed and arranged to display said industry trend information; wherein
said action consists of reviewing said industry trend information.

7. The enterprise sales management system of claim 2 further comprising:
a graphical database coupled to said a tele-agent dashboard engine, said graphical database designed and arranged for storing data in the form of triples defining a plurality of interconnected nodes, edges, and properties; and
said tele-agent dashboard engine designed and arranged to iteratively traverse said graphical database and apply semantic reasoning at each of said plurality of interconnected nodes; whereby
said a tele-agent dashboard engine and said graphical database cooperate to improve the overall processing efficiency of said automated computing machinery.

8. The enterprise sales management system of claim 2 further comprising:
a leaderboard display disposed on the tele-agent dashboard designed and arranged to display a performance ranking of a plurality of tele-agents;
said tele-agent dashboard engine operable to update said leaderboard display in real-time.

9. A process for improving the efficiency of an enterprise sales management system in communication with a computer-hosted accounting system, the process comprising the steps of:
producing a plurality of instances of a tele-agent dashboard on a plurality or tele-agent stations by a tele-agent dashboard engine implemented by said automated computing machinery;
querying said computer-hosted accounting system by said a tele-agent dashboard engine via an enterprise system gateway to obtain payroll and sales accounting data for each of said plurality of instances;
querying a graphical database by said a tele-agent dashboard engine to obtain non-accounting sales data;
populating by said tele-agent dashboard engine each of said plurality of instances with the payroll and sales accounting data and non-accounting sales data;
receiving by said tele-agent dashboard engine from a first of said plurality of instances a selection of an action button;
determining by said tele-agent dashboard engine a completion of an action specified by said selection;
posting compensation data to aid computer-hosted accounting system by said a tele-agent dashboard engine via said enterprise system gateway to reflect said completion;
updating said graphical database by said a tele-agent dashboard engine to reflect said completion; and
updating said first of said plurality of instances with said compensation data to reflect said completion; whereby
said, and said tele-agent dashboard provide an enhanced, efficient user interface of said enterprise sales management system.

10. The process of claim 9 further comprising the steps of:
populating said plurality of instances with leaderboard data to reflect a plurality of performance rankings; and
updating said leaderboard data on said plurality of instances to reflect said completion.

11. The process of claim 9 further comprising the steps of:
storing by said graphical database a plurality of triples defining a plurality of interconnected nodes, edges, and properties;
traversing said graphical database by one of the group consisting of said tele-agent dashboard engine and a machine learning engine; and
applying by said one of the group a semantic inference rule at each node of said plurality of triples; whereby
said one of the group and said graphical database cooperate to improve the overall processing efficiency of said automated computing machinery.

12. The process of claim 11 wherein:
said step of traversing said graphical database by one of the group occurs upon said completion.

13. The process of claim 9 further comprising the steps of:
providing by a customer relationship manager implemented by said automated computing machinery customer data reflecting interaction with a contact; and
populating by said tele-agent dashboard engine a customer relationship management interface region disposed on said first of said plurality of instances with said customer data.

14. The process of claim 9 further comprising the steps of:
querying by a dynamic lead generator implemented by said automated computing machinery an external sales analytics engine;
producing a company profile by said dynamic lead generator that identifies products of interest for a particular plurality of companies; and
populating by said tele-agent dashboard engine a dynamic lead generator interface region disposed on said first of said plurality of instances with information from said company profile.

15. The process of claim 9 further comprising the steps of:
querying by a dynamic script generator implemented by said automated computing machinery a plurality of remote industry resources;
producing industry trend information by said dynamic script generator; and
populating by said tele-agent dashboard engine a dynamic script generator interface region disposed on said first of said plurality of instances with said industry trend information.

16. The process of claim 9 wherein:
said action comprises one from the group consisting of creating, updating or reviewing a customer organizational chart, documenting a customer note, reviewing a customer social media account, sending a customer note or card, conducting a customer inventory analysis, reviewing information from a company profile, and reviewing industry trend information.
